(19) United States
(12) Patent Application Publication
(10) Pub. No.: US 2011/0042299 A1
(43) Pub. Date: Feb. 24, 2011

(54) COMPOSITE MEMBRANE ASSEMBLIES AND METHODS OF MAKING AND USING THE SAME

(75) Inventors: Anping Zhang, Rexford, NY (US); Rui Chen, Clifton Park, NY (US); Anthony John Murray, Lebanon, NJ (US)

Correspondence Address: GENERAL ELECTRIC COMPANY;GLOBAL RESEARCH, ONE RESEARCH CIRCLE, BLDG. K1-3A59, NISKAYUNA, NY, 12309, US

(73) Assignee: GENERAL ELECTRIC COMPANY, SCHENECTADY, NY (US)

(21) Appl. No.: 12/544,660

(22) Filed: Aug. 20, 2009

(51) Int. Cl. B01D 71/06; B01D 71/00; B01D 71/12; B01D 71/10; B01D 69/12; B01D 67/00; B05D 5/00; C23C 28/00

(52) U.S. Cl. 210/490; 427/244; 205/196

(57) ABSTRACT

A composite membrane assembly is provided. The composite membrane assembly comprises a porous substrate, a filtering membrane at least partially coupled to the porous substrate, a polymer membrane at least partially coupled to the filtering membrane, and an interface material at least partially disposed between the filtering membrane and the polymer membrane.

### BACKGROUND

The invention relates to membranes for filtration, and more particularly to composite membrane assemblies for filtration of biomolecules.

Typically, membrane filters are employed in biological applications involving separation of molecules in biological fluids. Most of the membrane filters employ polymer membranes or ceramic membranes. For example, cellulose and its derivatives, polysulfone, polyacrylonitride (PAN), poly(mththylmethacrylate) (PMMA), polyamide, polypropylene, polycarbonatem, polyester, polyvinylidene fluoride, anodic aluminum oxide are some of the materials used to make membranes. Disadvantageously, most of the existing membranes have broad pore size distribution. In other words, the sizes of the pores in a given membrane are inconsistent and vary greatly over a large range. Due to large pore size distribution, the separation process suffers significant product loss. For example, species pass through the filter due to large pore size distribution when they should be retained. Another disadvantage is that these membranes are quite thick and, as a result, have relatively low flux rates, thereby adversely affecting the throughput of the filtration process. The ceramic membranes typically lack the robustness needed to scale up for protein and other biomolecule processing.

Some demanding filtration applications, for example virus filtration or clearance, require very small pore sizes (15 nanometers to 35 nanometers) and high flux rate. The membrane needs to have very narrow pore distribution to achieve greater than 5 logs virus reduction. The filtration layer of the membrane also needs to be very thin to achieve high flux rates because the filtration resistance can be very high for a pore size in a range from about 15 nanometers to about 35 nanometers. The ultrathin inorganic membranes, such as silicon or silicon nitride membranes, have very narrow pore size distribution in a broad range of nanopores from 5 nanometers to greater than 1 micrometer, and very thin membrane layers from 10 nanometers to greater than about 1 micrometers.

Therefore, it would be desirable to provide a membrane that has uniform pore size distribution, high flux rate and enhanced robustness for use in the biomolecules filtration.

### BRIEF DESCRIPTION

In one embodiment, a composite membrane assembly is provided. The composite membrane assembly comprises a porous substrate, a filtering membrane at least partially coupled to the porous substrate, a polymer membrane at least partially coupled to the filtering membrane, and an interface material at least partially disposed between the filtering membrane and the polymer membrane.

In another embodiment, a method for making a composite membrane assembly. The method comprises providing a porous substrate having a filtering membrane disposed thereon, depositing an interface material on the filtering membrane, and disposing a polymer membrane on the interface material.

### DRAWINGS

These and other features, aspects, and advantages of the present invention will become better understood when the following detailed description is read with reference to the accompanying drawings in which like characters represent like parts throughout the drawings, wherein:

FIG. 1 is a cross-sectional view of an example of a composite membrane of the invention;

FIG. 2 is a cross-sectional view of another example of a composite membrane of the invention;

FIG. 3 is a flow chart illustrating an example of various steps involved in the fabrication of the composite membrane assembly of the invention; and

FIG. 4 is an example of a fabrication process for silicon or silicon nitride inorganic membranes.

### DETAILED DESCRIPTION

The composite membranes of the invention may be used for various filtration applications such as filtering viruses. In some of the embodiments, a composite membrane assembly comprises a porous substrate, a filtering membrane coupled to the porous substrate, a polymer membrane coupled to the filtering membrane, and an interface material disposed between the filtering membrane and the polymer membrane. As used herein, the term “interface material” refers to a material that is employed to bond the polymer membrane to the underlying surface, such as a surface of the filtering membrane, or a surface of the silica layer, or a surface of a metal layer that is disposed on the filtering membrane. In some embodiments, the interface material may be the same as the material of the polymer membrane.

Bioprocess production typically comprises seed and cell culture, cell harvest, clarification, virus removal, scavenger, ultra-filtration/dia-filtration, sterile filtration, and fill and finish. In each subsequent process contaminants are removed from the feed stream until only the target biological products remain. Each step incorporates filtration and/or other separation steps. In clarification operations, depth filters are commonly used. It is desirable to reduce the cost of the clarification step and use low leachables membranes in convenient single-use format.

The effluent of cell culture and harvest is a mixture of media, cells, cell fragments, colloidal particles and proteins. The mixture contains a wide distribution of particle sizes, and ranges from low to high concentrations of solids and colloids. A number of primary and secondary purification steps are combined to achieve target separation.

Viral clearance ensures final product safety and is an essential step, for example in mammalian cell and human plasma processes. Often the target proteins are similar in size to the smaller viruses, so the membrane must have a very small pore distribution to simultaneously achieve high virus removal with high protein recovery.

In addition, industry trends have shifted towards single-use, or disposable, technology. Regulatory issues, time to market and cost considerations are driving this shift. Reductions in capital investment, time to launch and cleaning steps, and elimination of cross-contaminations are benefits of the shift to disposables. Process flexibility is another advantage, as some of the systems scale down to accommodate smaller particle sizes and require switching from one product to another.

Since many of the target proteins in cells are expressed in low concentrations, purification processes must be efficient and cost effective. In conventional set-ups, the clarification step and virus filtration step are two separate steps that are carried out in succession. The composite membrane assemblies of the invention may be employed as depth filters, for example, to combine the clarification and virus separation steps, thereby improving the efficacy and efficiency of the filtration process. In these embodiments in which the composite membrane assembly is employed as a depth filter, the polymer membrane disposed on the filtering membrane facilitates removal of larger size debris, and the filtering membrane with smaller pores entraps smaller particles such as viruses. The polymer membrane acts as a screening layer and assists in removing aggregates of proteins and other larger size debris. In addition, the polymer membrane may act as a protection layer for the underlying filtering membrane. In some embodiments, the polymer membrane also assists in reducing or eliminating biofouling on the filtering membranes.

In certain embodiments, the composite membrane assembly is designed and made to have a large membrane area. For example, the diameter of the composite membrane assembly may have a diameter up to about 12 inches. The composite membrane assembly may also be designed and made to enable high flux rates. For example, the flux rate of the composite membrane assembly can be greater than 50 times the flux rate of commercially available virus filters. For example, the commercial Planova™ filter, having a pore size of about 20 nanometers, has a clean-water flux rate of about 40-60 L/(m².h), while the silicon or silicon nitride filtering membrane of the invention, having the same pore size (that is pore size of about 20 nanometers) and a thickness of about 100 nanometers, can have a clean-water flux rate of about 3000 L/(m².h). For example, in one embodiment, the clean-water flux rate of the composite membrane assembly is in a range from about 130 L/(m².h) under a 0.1 bar pressure differential for nanoproes having a size of about 15 nanometers, wherein a thickness of the filtering membrane is about 100 nanometers. In another embodiment, the clean-water flux rate of the composite membrane assembly is in a range from about 4100 L/(m².h) under a 1 bar pressure differential for nanoproes having a size of about 20 nanometers and a membrane thickness of about 100 nanometers

In some embodiments, the filtering membrane may be made of an inorganic material, such as silicon or silicon nitride. The silicon nitride membrane may be amorphous in nature. In embodiments where the filtering membrane is made of silicon, the membrane may be formed of single crystal silicon, poly-crystalline silicon or amorphous silicon. A membrane formed of single crystal silicon exhibits enhanced mechanical strength. For example, trans membrane pressure, acceptable in the case of single-crystal silicon membranes, can be about 6.9 atmospheres for a 90 nanometers thick single crystal silicon membrane having an aperture size of 100 microns by 100 microns. As used herein, the term “trans membrane pressure” refers to maximum pressure differential across the membrane before the membrane ruptures due to pressure experienced by the membrane.

A combination of high flux rate with narrow pore size distribution is suitable for differentiating biomolecules with similar sizes, for applications such as virus filtration or clearance from protein products, protein fractionation, protein purification, protein desalting, and the like. Accordingly, it is desirable to have a thin filtering membrane to facilitate high flux rates. In one example, the filtering membrane may be a silicon membrane having a thickness of about 40 nanometers. In another example, the filtering membrane may be a silicon nitride membrane having a thickness of about 30 nanometers.

In one embodiment, a silica layer may be disposed on a surface of the filtering membrane that is opposite to the surface that is coupled to the porous substrate. In another embodiment, a metal layer, such as gold layer, may be disposed on the surface of the filtering membrane.

The polymer membrane may include cellulose, a cellulose derivative, microcrystalline cellulose, cellulose acetate fibers, natural fibers, synthetic fibers, refined cellulose fibers, perlite, diatomaceous earth, or a cationic crosslinkable polymer. In instances where perlite or diatomaceous earth is used in the polymer membrane, the membrane assembly is structurally adapted to prevent the free flowing perlite and diatomaceous earth from clogging the filtering membrane underneath. Non-limiting examples of materials for polymer membrane may include polysulfone, polyacrylo nitride (PAN), poly(mththylmethacrylate) (PMMA), polyamide, polypropylene, polycarbonatem, polyester, polyvinylidene fluoride. The polymer membrane may include one or more of polycarbonates, cellulosics, polyamides, ethylene propylene, polyolefins, or polytetrafluoroethylene (PTFE). The thickness of the polymer membrane is in a range from less than about 1 nanometer to more than about 1000 micrometers. A thicker polymer membrane may be used, and is advantageous, as a protection layers for the inorganic filtering membrane.

In some embodiments, the polymer membrane has a small or narrow pore size distribution. For example, the pore size distribution of the polymer membrane may be in a range from about 15 nanometers to about 1 micrometer. The narrow pore size distribution of the pores facilitates minimal product loss, while facilitating high flux rate. In certain embodiments, the pore size in the polymer membrane may gradually increase in the direction away from the filtering membrane. In these embodiments, the polymer membrane may have a higher thickness value. For example, the thickness of the polymer membrane may be in a range from about 100 microns to about 1000 micrometers.

The interface material may be any material that bonds to the filtering membrane as well as to the polymer membrane. For example, the interface material may be a polymeric material. Non-limiting examples of the interface material may include a polyethylene, a silane derivative, or a bromine derivative. In one embodiment, the pore sizes of the interface material may be similar to that of the underlying filtering membrane. In another embodiment, the pore size may be larger than the pore size in the filtering membrane.

The interface material may be either a continuous layer, or a non-continuous layer. In some embodiments, for example, the interface material may be disposed on only selective portions of the filtering membrane. The remaining portions of the filtering membrane, that do not have the interface material, may receive the filtered entity from the polymer membrane directly, without having to pass the filtered entity through the interface material.

In one embodiment, the porous substrate may include a network of pores formed from pore columns and branched pores, which may be linked to each other to form a continuous network of pores. As used herein, the term “pore columns” refers to pores that are generally columnar in shape and are formed during the anodization process. The pore columns may be formed by selective removal of the material of the substrate from predetermined places during processing of the membrane assembly, thereby forming a plurality of empty spaces or pore columns The pore columns are typically arranged alternately with the columns of the material of the substrate. As used herein, the term “branched pores” refers to pores that are formed in the columns of the material of the substrate. The branched pores connect the pore columns to provide a continuous network of pores in the substrate. In certain embodiments, the substrate may be an anodized substrate. As used herein, the term “anodized substrate” refers to a substrate that comprises pores formed by anodization of the substrate. The pores formed by anodization may be of different shapes and sizes, such as circular pores or columnar pores. In addition, the anodized substrate may also include pores formed by etching.

In one embodiment, the porous substrate may include macropores. As used herein, the term ‘macropores” refers to pores in the substrate that may include pore columns and/or branched pores formed by anodization, or pores formed by standard lithography followed by etching, such as but not limited to plasma etch or wet chemical etch. The macropores may have a diameter in a range from about 1 micron to about 500 microns. The branched pores are typically smaller in size than the pore columns In one embodiment, the diameter of the branched pores may be in a range from about 0.2 microns to about 1 micron. Both the pore columns and the branched pores may be formed by anodization of the substrate. The pore network in the anodized substrate increases porosity of the filtering membrane.

Proteins and other molecules with different molecular weight may be differentiated using different pore sizes. In addition, functionalization of the pore surfaces of the inorganic filtering membrane may further adjust the effective pore size in the filtering membrane and enable the filtering membrane to differentiate molecules with similar molecular weight but different charges. In one embodiment, at least a portion of the membrane may be functionalized with a chemical, a biomolecule, an antibody, or combinations thereof.

In one example, the thickness of the filtering membrane is increased from about 40 nanometers to a size in a range from about 100 nanometers to about 500 nanometers to enhance the robustness of the inorganic membrane. The membrane apertures or pore columns of the inorganic membrane is reduced from 200 micrometers to a size in a range from about 50 micrometers to about 100 micrometers to enhance the robustness of the inorganic membrane. The increase in the number of pore columns may result in an increased total filtering area of the membrane assembly.

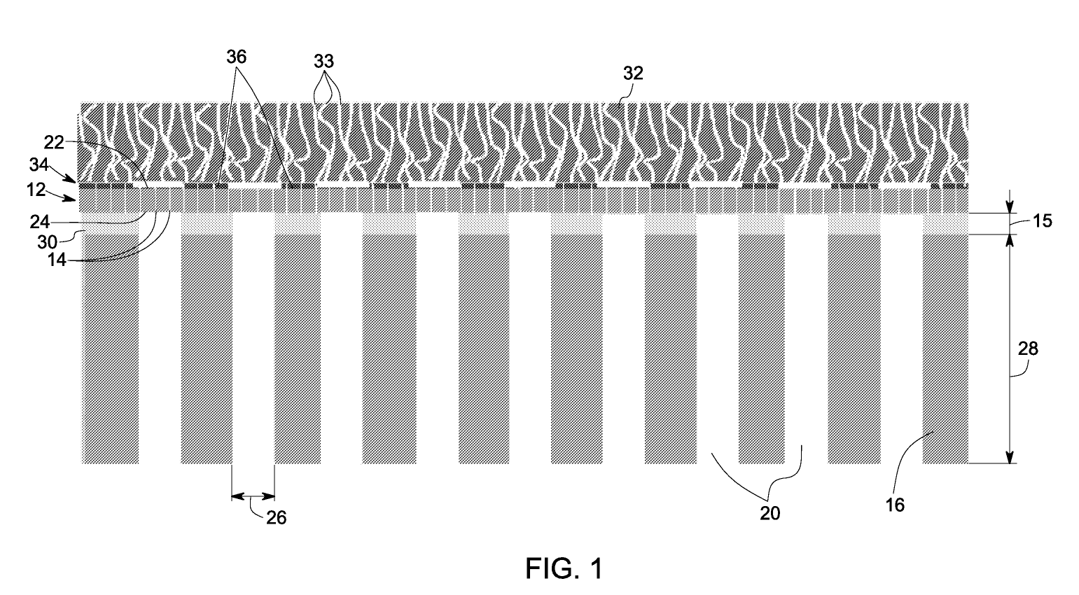

FIG. 1 illustrates a composite membrane assembly 10 comprising an inorganic filtering membrane 12 having top and bottom surfaces 22 and 24, respectively. The filtering membrane 12 includes a plurality of pores 14. In one embodiment, the filtering membrane 12 has a diameter of about 12 inches. In one embodiment, the size of the pores 14 may be in a range from about 5 nanometers to about 500 nanometers. In one embodiment, the size of the pores 14 may be in a range from about 10 nanometers to about 50 nanometers. The thickness 15 of the filtering membrane 12 may be in a range from about 10 nanometers to about 50 nanometers, from about 50 nanometers to about 100 nanometers, from about 100 nanometers to about 500 nanometers, from about 500 nanometers to about 5000 nanometers, or less than about 15 nanometers. The filtration resistance or transport resistance of the membrane assembly is typically dominated by the resistance in the filtering membrane 12. A thin filtering membrane 12 reduces filtration or transport resistance of the fluid through the membrane 12 and enables high flux rate during filtration.

In one embodiment, the filtering membrane 12 may be coupled to a porous substrate 16 on one side. The porous substrate 16 may be an anodized substrate. The porous substrate 16 may include a plurality of macropores that include pore columns 20. The pore column diameter 26 may be varied depending on the type of application of the membrane assembly 10. As used herein, the term “pore column diameter” refers to the size of the membrane apertures. In one embodiment, the pore column diameter 26 may be in a range from about 5 micrometers to about 500 micrometers. The decrease in the pore column diameter 26 increases the robustness of the filtering membrane 12.

In one example, the thickness 28 of the porous substrate 16 is in a range from about 50 micrometers to about 1000 micrometers, or from about 300 micrometers to about 500 micrometers. The porosity of the substrate 16 is in a range from about 30 percent to about 90 percent, from about 40 percent to about 60 percent, or from about 50 percent to about 70 percent. In one embodiment, the porosity of the substrate 16 may be equal to or greater than about 70 percent.

In one embodiment, the composite membrane assembly 10 may include an intermediate layer 30 disposed between the filtering membrane 12 and the substrate 16. As illustrated, the intermediate layer 30 may include channels that are continuation of the pore columns 20 of the substrate 16. The intermediate layer 30 may be made of silicon dioxide or silicon nitride, if the filtering membrane 12 is made of silicon. However, the intermediate layer may be optional if the filtering membrane 12 is silicon nitride.

The filtering membrane 12 may be coupled to a polymer membrane 32 on the side opposite to that of the substrate 16. The polymer membrane 32 includes a plurality of pores 33. The polymer membrane 32 is coupled to the filtering membrane 12 by employing an interface material 34 disposed between the filtering membrane 12 and the polymer membrane 32. In the illustrated embodiment, the interface material 34 includes patterns 36.

In certain embodiments, the interface material may be disposed on the filtering membrane in various patterns. The interface material may be initially laid in the form of a continuous layer and then patterned, the undesired portions of the interface materials may be cleaned by oxygen plasma. In instances where the interface material is in the form of a continuous layer, the layer may cover only a certain amount of portion of the underlying filtering membrane. The interface material may be a continuous layer, a patterned layer (the patterned layer may have a continuous pattern or a discontinuous pattern), or discrete portions.

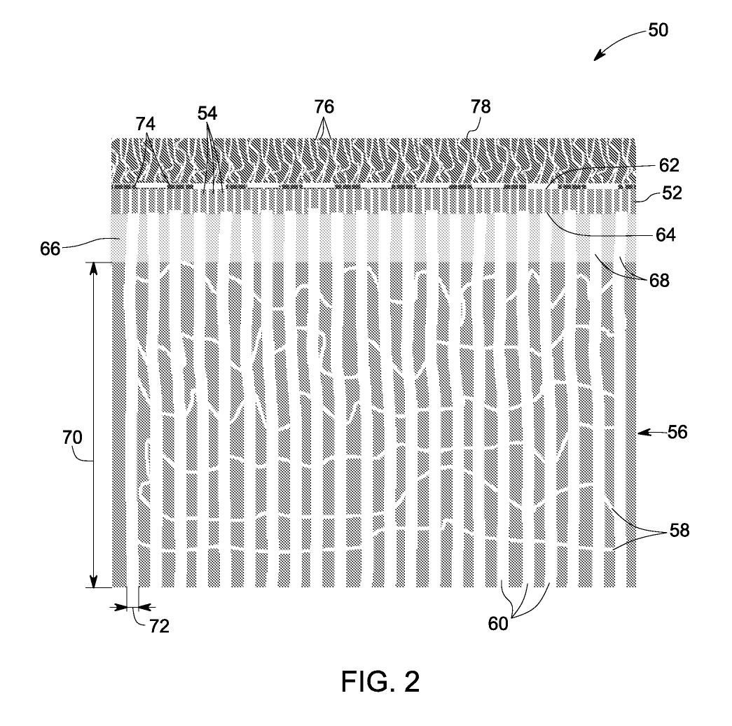

FIG. 2 is an alternate embodiment of the composite membrane assembly of FIG. 1. In the illustrated embodiment, the composite membrane assembly 50 comprises an inorganic filtering membrane 52 and a porous substrate, such as anodized substrate 56. The filtering membrane 52 has a top surface 62 and a bottom surface 64 and includes a plurality of pores 54. The bottom surface 64 is attached to an intermediate layer 66 having pore columns 68. The intermediate layer 66 may be made of silicon oxide or silicon nitride. The intermediate layer 66 may be optional if the filtering membrane 52 is made of silicon nitride. The intermediate layer 66 works as an etch stop layer during fabrication of the pore columns 68.

The substrate 56 includes branched pores 58 and pore columns 60. The branched pores 58 connect the vertical pores or pore columns 60 to one another. The branched pores 58 connect the pore columns 60 to form a continuous network of pores in the substrate 56. In the illustrated embodiment, the macropores, that is the pore columns 60 and the branched pores 58 of the substrate 56 may be present throughout the thickness 70 of the anodized substrate 56. The pore networks formed from the pore columns 60 and branched pores 58 increase the porosity of the substrate 56 and enhance the throughput of the membrane assembly 50. The pore column diameter 72 may be in a range from about 5 micrometers to about 5000 micrometers. The thickness 70 of the anodized substrate 56 may be kept higher to provide mechanical strength, or to suit the structural requirements of the device employing the composite membrane assembly 50. The pore columns 60 may be formed by employing standard lithography followed by plasma etch or wet chemical etch.

In the illustrated embodiment, a polymer membrane 78 is coupled to the filtering membrane 52 using an interface material 74. The interface material 74 is in the form of discrete portions that are disposed on the filtering membrane 52. The polymer membrane 78 may have a thickness in a range from about 1 nanometer to about 1000 micrometers.

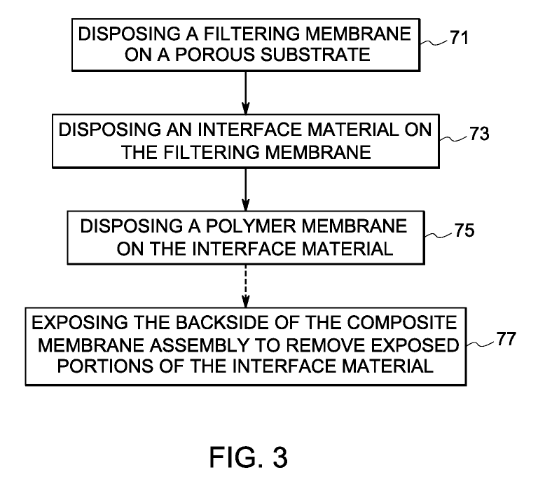

As illustrated in FIG. 3, in certain embodiments, a method for making the composite membrane assembly is provided. At block 71, an inorganic filtering membrane layer is disposed on a porous substrate and has a plurality of pores. The plurality of pores of the filtering membrane may be fabricated by methods such as, but not limited to, self-assembly of block copolymers, or nano-imprint lithography. Typically, block copolymers are two different polymer chains covalently bonded together on one end and molecular connectivity may force phase separation to occur on molecular-length scales. As a result, periodically ordered structures, such as cylinders, may be formed. The cylinders may be of nanometer size. The sizes and periods of the cylinders may be governed by the chain dimensions of the block copolymers. Further, the sizes and periods of the cylinders may be about 10 nanometers to about 50 nanometers. Although structures smaller than about 10 nanometers may also be obtainable, if appropriate blocks are chosen. For example, blocks of the copolymer with a high Flory-Huggins interaction parameter and decreased block lengths may be used to obtain structures smaller than about 10 nanometers. In one embodiment, the pores in the substrate are formed at least in part using anodization. The process of anodization may include applying a voltage or current between the established electrode and the electrolyte. In these embodiments, the substrate may be single-crystal silicon. In one embodiment, a conducting layer is disposed on the substrate prior to forming the plurality of pores in the substrate. This may be achieved by ion implantation followed by thermal activation.

At block 73, an interface material is disposed on the filtering membrane. In one embodiment, the interface material may be deposited in the form of a continuous layer. In another embodiment, the interface material may be deposited in the form of discrete portions by employing methods such as, but not limited to, stamping, direct write method. In embodiments where the interface material is in the form of a continuous layer, the interface material may be disposed by employing coating techniques.

At block 75, a polymer membrane may be coupled to the filtering membrane using the interface material. In certain embodiments, the polymer membrane may be bonded or synthesized in-situ the interface material. In instances where the polymer membrane is grown in-situ, the material of the polymer membrane may be the same as that of the interface material. In these embodiments, the polymer membrane may have a lower thickness values in a range from about 1 nanometer to about 1 micrometer. Optionally, at block 77, the back side of the composite membrane assembly, that is the surface opposite to the filtering membrane, may be exposed to oxygen plasma to remove exposed portions of the interface material through the pore columns

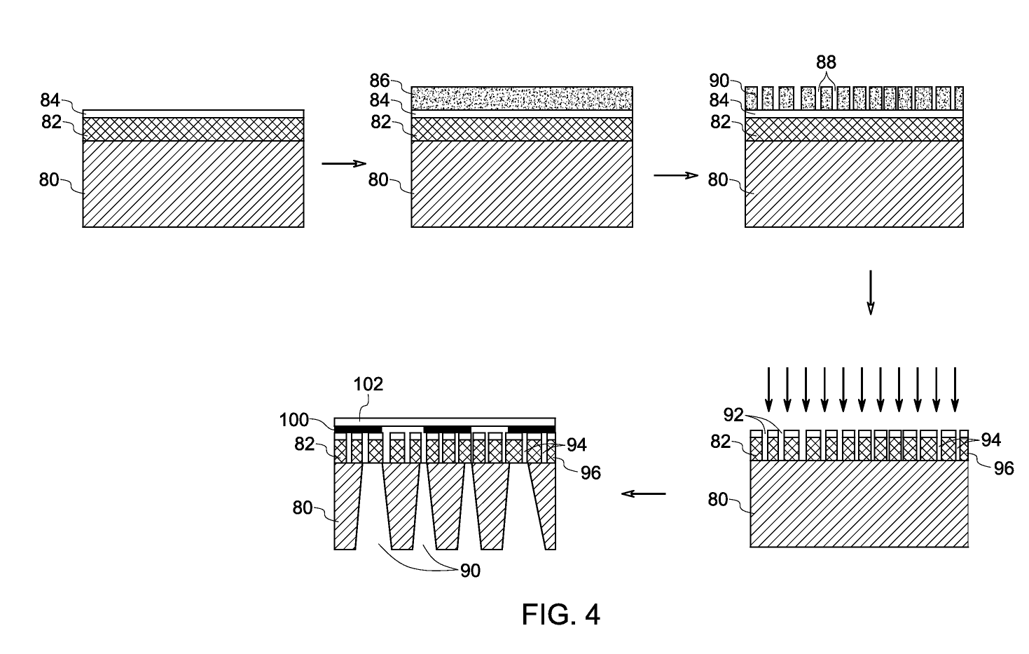

FIG. 4 illustrates steps involved in a method of making a composite membrane assembly. In the illustrated embodiment, a silicon substrate 80, having a silicon or silicon nitride layer 82 disposed on one side, is provided. Although not illustrated, an intermediate layer of silicon dioxide or silicon nitride may be disposed on the silicon substrate in instances where the layer 82 is made of silicon. Although not illustrated, in one embodiment, a silicon-on-insulator (SOI) wafer may be employed in place of the silicon substrate 80. The SOI wafer may include a first silicon layer, a silica insulator layer, and a second silicon layer disposed on the silica insulator layer. The insulator layer may act as the etch stop layer during subsequent processing. The diameter of the silicon nitride layer 82 may be up to 12-inches. The silicon nitride layer 82 may have a stress of less than about 250 MPa, or less than about 100 MPa, or even less than about 50 MPa. The silicon nitride layer 82 may be made as thin as about 10 nanometers. A thin silica layer 84 or a metal layer, such as gold layer, is then formed on the top silicon nitride layer 82. The silica layer 84 may be formed by deposition techniques such as, but not limited to, thermal oxidation (steam oxidation or dry oxidation) in a furnace at a temperature in a range from about 900° C. to about 1200° C., sputtering, e-beam evaporation, chemical vapor deposition (CVD), such as plasma enhanced chemical vapor deposition (PECVD). The silica layer 84 may be in the form of a thin film having a thickness in a range from about 10 nanometers to about 30 nanometers.

Next, a block copolymer mixture is spin coated on the silica layer 84 in the form of a coating 86, for example. The thickness of the block copolymer coating 86 may be in a range from about 20 nanometers to about 100 nanometers. In one example, a thickness of the block copolymer coating 86 is in a range from about 20 nanometers to about 25 nanometers. In one example, polystyrene (PS) and poly(methyl methacrylate) (PMMA) block copolymers may be deposited on the silica layer 78. The size of the pores of the filtering membrane may be varied by varying the molecular weight of the block copolymers. In one embodiment, the size of the pores of the filtering membrane is in a range from about 10 nanometers to about 50 nanometers. In one example, the pore size of the filtering membrane, when using PS-b-PMMA copolymers, is about 15 to 20 nanometers.

In some embodiments, the block copolymer coating may be annealed. The annealing may be done above the glass transition temperature of the block copolymers. The annealing above the glass transition temperature may facilitate formation of well-ordered cylinders in the block copolymer coating. In one example, the annealing may be done in vacuum at a temperature of about 170° C. Subsequent to annealing, portions 88 of the block copolymer coating may be dissolved and remaining portions 90 may be used for formation of pores in the underlying silica layer 84. For example, when employing polystyrene (PS) and poly(methyl methacrylate) (PMMA) block copolymers, the PMMA phase may be selectively dissolved (for example in glacial acetic acid) and the remaining PS phase may be used in the formation of the pores in the underlying silica layer 84.

Next, the selectively dissolved copolymer coating 86 may be anisotropically etched to remove portions of the underlying silica layer 84 to form pores 92 in the silica layer 84. In one example, trifluoromethane (CHF₃) may be used to selectively remove silica and form pores 92 in the silica layer 84. Selective etching may be done in a Reactive Ion Etch (RIE) chamber. Subsequently, another etching treatment may be carried out to form pores 94 in the silicon nitride layer 82 to form the filtering membrane 96. In one embodiment, instead of silicon the layer 82 may contain silicon nitride. In one example, the filtering membrane 96 is formed such that the porous surface area of the membrane has a diameter up to 12-inches. In one example, the etching of the silicon layer 82 may be carried out by plasma comprising a combination of hydrogen bromide, chlorine and oxygen with the silica layer 84 acting as etch mask. In another example, the silicon nitride layer 82 may be etched by plasma comprising fluorine, oxygen and nitrogen. This step may be performed in a reactive ion etch (RIE) chamber, an Inductively Coupled Plasma (ICP) etcher, or an electron cyclotron resonance (ECR) plasma etcher, and the like.

Subsequently, pores, such as pore columns 90 are formed in the substrate 80. In one example, the wafer may be anodized in hydrofluoric acid (HF) based solutions. Non-limiting examples of HF based solutions may include aqueous solution of HF with ethanol, an organic solution of HF with dimethyl sulfoxide (DMSO), an organic solution of HF with dimethyl formamide (DMF), hydrofluoric acid with an inorganic solution (such as Buffered Oxide Etch), or combinations thereof. The concentration and the applied current in the electrolytic cell during etching may be varied and optimized with respect to etching rate and suitability of the resulting structure. In another example, the pores 90 may be formed by standard lithography, followed by plasma etch or wet etch or combination.

Subsequent to anodization of the substrate 80, interface material 100 is deposited on the silica layer 86. Next, a polymer membrane 102 may be bonded to the silica layer 86 using the interface material 100. A thin layer of homo-polymers or block copolymers may be attached on the surface of the silica layer 86 via physisorption. The interaction between the polymer and the surface via physisorption is usually not so strong as it is in most cases caused by van der Waals forces or is due to hydrogen bonding, and are often thermally unstable due to the low interaction between the polymer and the solid substrate. The interface material may also be covalently attached on the silica layer 86 surface with much stronger adhesion. In another embodiment, the polymer layer may be covalently attached on the silica surface. The covalent coating may be polyethylene (PEG). Covalently bound polymers have much stronger adhesion on the silica surface. In one example, the surface of the silica layer 86 may be treated with amino trimethoxy silane and then coated with PEG. The surface of the silica layer 86 may be treated with about 0.1 percent to about 1 percent PEG silane in toluene with 0.1 percent hydrochloride. Non-limiting example of PEG silane compositions include 2-methoxy(polyethyleneoxy)propyl)-trimethoxysilane. Surface initiated polymerization may also be used to form covalent bonds between polymers of the polymer membrane 102 and the surface of the silica layer 86. For example, an initiator may be grafted on the surface of the silica layer 86 by vapor deposition or wet chemistry treatment. Non-limiting examples of the initiator may include 2-bromoisobutyryl bromide, (2-bromo-2-methyl-propyloxyl)propyl-dimethyl-chlorosilane. A thin layer of polymer can be grown via atom transfer radical polymerization.

In embodiments where a metal layer, such as gold layer, is disposed on the filtering membrane 96, a self-assembled monolayer (ASM) of alkanethiol may be covalently attached on the gold layer by forming a self-assembled monolayer of long-chain alkanethiols with suitable reactive groups on one end of the molecule and a gold-complexing thiol on the other. Both chemisorbed and physisorbed alkanethiol molecules can be involved during monolayer formation, with the overall formation kinetics determined by the relative solubility of the alkanethiol in the solvent (ethanol or heptane). In another example, a flexible hydrogel matrix composed of carboxylmethylated dextran chains may be used to form a porous three-dimensional linking matrix. Additionally, silanes polypeptides or polymer films also may be attached on the gold surface. In one example, a polymer linker layer can be formed by plasma polymerization deposition using glow discharge or a plasma of organic vapors. The resulting film is homogeneous, and is extremely thin with a thickness of less than about 100 nanometers and has good adhesion to the gold layer.

In one embodiment, the polymer membrane 102 may be formed separately, and attached to the filtering membrane 96. The polymer membrane 102 is formed via phase inversion technique that relies on the phase separation of polymer solutions to produce porous polymer membrane 102. Phase separation mechanisms can generally be subdivided in three main categories depending on the parameters that induce de-mixing or phase separation. In temperature induced phase separation (TIPS), change in temperature at the interface of the polymer solution, results in heat exchange and induces de-mixing. The polymer solution can be subjected to a reaction which causes phase separation, also known as reaction induced phase separation (RIPS). The most commonly used technique is based on diffusion induced phase separation (DIPS). By contacting a polymer solution to a vapor or liquid, diffusional mass exchange takes place which leads to a change in the local composition of the polymer film and induces de-mixing.

In one embodiment, the polymer membrane can be attached to the interface material via covalent bonds. Optionally the polymer membrane may be treated with oxygen plasma prior to the attachment. Typically the adhesion between the interface layer and the polymer membrane is sufficient to maintain the mechanical integrity of the system for filtration. In another embodiment, the polymer membrane may be synthesized on the interface materials, for example, via surface initiated polymerization.

The composite membrane assembly may be employed to remove viruses during the manufacture of bio-therapeutic drug products such as biopharmaceuticals and plasma derivatives, or commercial production of therapeutic products. In one example, separation of biomolecules may include clearance of viruses from protein products. The thin but robust filtering membrane enabled by nanopores in a range from about 15 nanometers to about 50 nanometers in the inorganic filtering membrane layer reduces the filtration resistance and increases the flux-rate of the protein products. The very narrow pore size distribution in the filtering membrane enables efficient separation of viruses from the protein products while maintaining high flux-rate of the protein products. For example, the membrane assembly having a filtering membrane with a thickness of about 100 nanometers and pore size of about 20 nanometers may provide greater than 50 to 100 times flux-rate of the protein products compared with some polymer-based virus filtering membranes.

While only certain features of the invention have been illustrated and described herein, many modifications and changes will occur to those skilled in the art. It is, therefore, to be understood that the appended claims are intended to cover all such modifications and changes as fall within the scope of the invention.

1. A composite membrane assembly, comprising:
a porous substrate;
a filtering membrane at least partially coupled to the porous substrate;
a polymer membrane at least partially coupled to the filtering membrane; and
an interface material at least partially disposed between the filtering membrane and the polymer membrane.

2. The composite membrane assembly of claim 1, wherein the interface material comprises a polyethylene, a silane derivative, or a bromine derivative.

3. The composite membrane assembly of claim 1, wherein the interface material is a continuous layer, a non-continuous layer, or a patterned layer.

4. The composite membrane assembly of claim 1, wherein the polymer membrane comprises cellulose, a cellulose derivative, microcrystalline cellulose, cellulose acetate fibers, natural fibers, synthetic fibers, refined cellulose fibers, perlite, diatomaceous earth, or a cationic crosslinkable polymer.

5. The composite membrane assembly of claim 1, wherein a thickness of the polymer membrane is in a range from about 1 nanometer to about 1000 micrometers.

6. The composite membrane assembly of claim 1, wherein a pore size distribution of the polymer membrane is in a range from about 50 nanometers to about 10 micrometers.

7. The composite membrane assembly of claim 1, wherein a flux rate of the composite membrane assembly is in a range from about 100 L/(m².hour) to about 20,000 L/(m².hour).

8. The composite membrane assembly of claim 1, wherein the filtering membrane comprises silicon or silicon nitride.

9. The composite membrane assembly of claim 1, further comprising a functionalized coating on the filtering membrane to facilitate separation of biomolecules.

10. The composite membrane assembly of claim 1, further comprising a silica layer disposed between the substrate and filtering membrane.

11. The composite membrane assembly of claim 1, wherein at least a portion of the filtering membrane is functionalized.

12. The composite membrane assembly of claim 1, wherein a thickness of the filtering membrane is in a range from about 10 nanometers to about 500 nanometers.

13. The composite membrane assembly of claim 1, wherein a porosity of the substrate is in a range from about 50 percent to about 80 percent.

14. The composite membrane assembly of claim 1, wherein the substrate comprises silicon, or silica.

15. The composite membrane assembly of claim 1, wherein the membrane assembly has a diameter of up to about 12 inches.

16. A method for making a composite membrane assembly, comprising:
providing a porous substrate having a filtering membrane disposed thereon;
depositing an interface material on the filtering membrane; and
disposing a polymer membrane on the interface material.

17. The method of claim 16, wherein the step of disposing the polymer membrane comprises in-situ growing the polymer membrane on the interface material.

18. The method of claim 16, wherein the step of disposing the polymer membrane comprises bonding the polymer membrane to the interface material.

19. The method of claim 16, wherein the step of depositing an interface material comprises:
depositing the interface material in the form of a layer; and
patterning the layer to remove portions of the interface material.

20. The method of claim 16, wherein the step of depositing an interface material comprises depositing the interface material in discrete portions of an underlying surface.

21. The method of claim 16, wherein providing the substrate comprises anodizing the substrate to form pore columns and branched pores.
